(19) United States
(12) Patent Application Publication
(10) Pub. No.: US 2014/0356571 A1
(43) Pub. Date: Dec. 4, 2014

(54) COMPOSITION FOR HEAT INSULATOR, HEAT INSULATOR, AND SPACECRAFT EQUIPPED THEREWITH

(71) Applicants: MITSUBISHI HEAVY INDUSTRIES, LTD., Tokyo (JP); LIGNYTE CO., LTD, Osaka (JP)

(72) Inventors: Junko Watanabe, Tokyo (JP); Aiichiro Tsukahara, Tokyo (JP); Masayuki Yamashita, Tokyo (JP); Fumihito Takeda, Tokyo (JP); Hisato Higuchi, Osaka (JP); Shinsuke Takeda, Osaka (JP); Nagaharu Hara, Osaka (JP)

(73) Assignee: LIGNYTE CO., LTD, Osaka (JP)

(21) Appl. No.: 14/369,846

(22) PCT Filed: Jan. 16, 2013
(86) PCT No.: PCT/JP2013/050696

§ 371 Date: Jun. 30, 2014

(30) Foreign Application Priority Data
Jan. 17, 2012 (JP) 2012-007097

(51) Int. Cl. B64G 1/58; C08L 61/06; C08J 9/00; B32B 5/26; B32B 5/24

(52) U.S. Cl. CPC B64G 1/58; B32B 5/26; B32B 5/245; C08J 9/0066; C08L 61/06; B32B 2250/02; B32B 2250/24; B32B 2307/304; B32B 2305/72; B32B 2605/18; B32B 2266/02; B32B 2250/22; B32B 2262/14; C08L 2205/025; C08J 2361/10
USPC 428/117; 428/316.6; 252/62

(57) ABSTRACT

A composition for a heat insulator, a heat insulator, and a spacecraft equipped with the heat insulator are provided which are able to satisfy a desired level of heat insulation performance while suppressing recession. The composition for a heat insulator comprises a fibrous substance, inorganic foam particles, a thermosetting resin and a foaming agent, wherein the fibrous substance includes at least a first fibrous substance, and a second fibrous substance composed of a material different from the first fibrous substance, the melting point of the first fibrous substance is higher than the melting point of the second fibrous substance, and the thermal conductivity of the second fibrous substance is lower than the thermal conductivity of the first fibrous substance.

### TECHNICAL FIELD

The present invention relates to a composition for a heat insulator, a heat insulator and a spacecraft equipped with the heat insulator, which can be used in the atmosphere or in a vacuum.

### BACKGROUND ART

Reentry vehicles such as space shuttles used in space are exposed to very high airframe surface temperatures of approximately 2,000° C. as a result of aerodynamic heating when the vehicle enters the atmosphere. In order to protect the airframe from these high temperatures, a heat insulator is used on the airframe. Examples of the heat insulators used on space shuttles and the like include insulators prepared by mixing microballoons and short fibers into a thermosetting resin, and subsequently heat-curing the thermosetting resin (see Patent Document 1).

The heat insulator disclosed in Patent Document 1 has a structure such that, when exposed to a rapid temperature increase during reentry into the atmosphere, heat energy is consumed by decomposition and carbonization of the insulator itself, thereby preventing the interior of the airframe from reaching high temperatures.

### CITATION LIST

### Patent Literature

{PTL 1} Japanese Unexamined Patent Application, Publication No. Hei 9-239847 (claim 1, paragraph 0013)

### SUMMARY OF INVENTION

### Technical Problem

Heat insulators used in space shuttles and the like are exposed to high temperatures, and therefore require superior heat insulation performance as well as a reduction in the amount of recession. The amount of recession refers to the amount by which the dimensions of the heat insulator are reduced as a result of melting, scattering and wear when the heat insulator is exposed to heating.

In conventional heat insulators, one of each of a series of components such as a thermosetting resin, foam particles and a fibrous substance are mixed together. Of the components included in the heat insulator, the fibrous substance may exhibit various differing properties depending on the type of fiber used. For example, in Patent Document 1, a single type of carbon fiber is used as the fibrous substance. Although carbon fiber is able to reduce recession, its heat insulation performance is not particularly high. In comparison, silica fiber has excellent heat insulation performance, but produces a larger amount of recession. As a result, all of the current technologies require some improvement in properties in order to enable practical application within products.

The present invention has been developed in light of these types of circumstances, and has an object of providing a composition for a heat insulator, a heat insulator, and a spacecraft equipped with the heat insulator, which are able to satisfy a desired level of heat insulation performance while suppressing recession.

### Solution to Problem

In order to achieve the above object, a first aspect of the present invention provides a composition for a heat insulator comprising a fibrous substance, inorganic foam particles, a thermosetting resin and a foaming agent, wherein the fibrous substance includes at least a first fibrous substance and a second fibrous substance composed of a material different from the first fibrous substance, the melting point of the first fibrous substance is higher than the melting point of the second fibrous substance, and the thermal conductivity of the second fibrous substance is lower than the thermal conductivity of the first fibrous substance.

Further, a second aspect of the present invention provides a heat insulator comprising a heat insulation layer obtained by foaming and curing a composition for a heat insulator comprising at least inorganic foam particles, a thermosetting resin, a foaming agent, a first fibrous substance and a second fibrous substance composed of a material different from the first fibrous substance, wherein the melting point of the first fibrous substance is higher than the melting point of the second fibrous substance, and the thermal conductivity of the second fibrous substance is lower than the thermal conductivity of the first fibrous substance.

The first fibrous substance with a high melting point has the effect of reducing recession. The second fibrous substance with a low thermal conductivity has the effect of improving the heat insulation properties. According to the invention described above, by mixing two or more types of fibrous substances having different properties, a heat insulator having a combination of these properties can be obtained.

In the second aspect described above, the heat insulator has another heat insulation layer provided on the underside of the heat insulation layer described above, this other heat insulation layer obtained by foaming and curing a composition for a heat insulator comprising inorganic foam particles, a thermosetting resin, a foaming agent, and only the aforementioned second fibrous substance as a fibrous substance.

The heat insulator is formed with a 2-layer structure, with the heat insulation layer disposed on the surface side of the heat insulator, and the other heat insulation layer disposed on the underside of the heat insulator. The heat insulation layer on the surface side is a layer containing two or more mixed fibrous substances, and mainly has the role of reducing recession. The other heat insulation layer on the underside is formed from a material having low thermal conductivity, and has a main function of providing heat insulation. By providing this other heat insulation layer on the underside, the heat insulation properties of the heat insulator can be improved, and recession can be better reduced. In this description, when the heat insulator is applied to use on the airframe of a spacecraft or the like, the surface of the heat insulator is deemed to be the surface positioned on the outside surface of the airframe and exposed directly to high temperatures.

In the heat insulation layer described above, the proportion of the first fibrous substance relative to the total amount of fibrous substances may be increased in either a stepwise or a continuous manner from the underside toward the surface of the heat insulation layer.

The heat insulator is a member which, when exposed to a high temperature at the surface of the heat insulator, has the role of preventing transmission of the high temperature to the underside of the heat insulator, but the surface side of the heat insulator also requires good suppression of the amount of recession. According to the second aspect described above, because the proportion of the first fibrous substance having a higher melting point is greater at the surface side of the heat insulator, the amount of recession can be reduced. On the other hand, at the underside of the heat insulator, because the proportion of the first fibrous substance is reduced and the proportion of the second fibrous substance having a lower thermal conductivity is greater, the heat insulation properties can be improved. As a result, a heat insulator which combines the advantages of a plurality of fibrous substances can be obtained.

In the second aspect described above, the heat insulator may be formed by foaming and curing the heat insulator composition A and the heat insulator composition B inside the spaces within a honeycomb structure. By using this technique, the honeycomb structure functions as a framework, enabling a heat insulator of superior strength to be obtained.

By providing a heat insulator obtained by mixing two or more types of fibrous substances having the different properties described above on a spacecraft, the airframe can be more reliably protected from aerodynamic heating when the spacecraft enters the atmosphere from space.

### Advantageous Effects of Invention

According to the present invention, by mixing two types of fibrous substances, a composition for a heat insulator, a heat insulator, and a spacecraft equipped with the heat insulator can be obtained which are able to maintain favorable heat insulation properties while suppressing recession.

### BRIEF DESCRIPTION OF DRAWINGS

FIG. 1 A schematic cross-sectional view illustrating the layer structure of a heat insulator according to a first embodiment.

FIG. 2 A schematic cross-sectional view of the heat insulator according to the first embodiment.

FIG. 3A A diagram illustrating an example of the shape of spaces within a honeycomb structure.

FIG. 3B A diagram illustrating an example of the shape of spaces within a honeycomb structure.

FIG. 3C A diagram illustrating an example of the shape of spaces within a honeycomb structure.

FIG. 3D A diagram illustrating an example of the shape of spaces within a honeycomb structure.

FIG. 3E A diagram illustrating an example of the shape of spaces within a honeycomb structure.

### DESCRIPTION OF EMBODIMENTS

Am embodiment of the composition for a heat insulator and heat insulator according to the present invention is described below with reference to the drawings.

### First Embodiment

A composition for a heat insulator according to this embodiment comprises a fibrous substance, a thermosetting resin, inorganic foam particles, and a foaming agent. The elements contained within the heat insulator composition, excluding the foaming agent, are combined to produce a total of 100% by mass.

Although there are no particular limitations, the thermosetting resin is preferably included within the heat insulator composition in a blend proportion of at least 10% by mass but not more than 60% by mass. The thermosetting resin mainly performs the role of a binder. If the blend amount of the thermosetting resin is less than 10% by mass, then the adhesive strength may be inadequate, and there is a possibility that the strength may be inadequate when used as a heat insulator. Further, it is desirable that the heat insulators used in spacecraft such as space shuttles or reentry capsules are lightweight, but if the blend amount of the thermosetting resin exceeds 60% by mass, then the bulk density upon preparation of a heat insulator is too high, and producing a lightweight material becomes difficult.

There are no particular limitations on the thermosetting resin, and examples include phenol resins, furan resins, polyimides, silicon resins, epoxy resins, unsaturated polyester resins, polyurethanes, melamine resins, and modified resins of these resins. A single type of thermosetting resin may be used alone as the thermosetting resin, or a combination of a plurality of types of thermosetting resin may be used.

In this embodiment, a phenol resin is used as the thermosetting resin. The phenol resin may be either a novolac type resin or a resol type resin. An individual novolac type resin or resol type resin may be used alone, or a mixture containing arbitrary proportions of both types of resin may be used. Further, any of various modified phenol resins such as silicon-modified, rubber-modified or boron-modified resins may also be used.

The phenol resin can be prepared by reacting a phenol and an aldehyde in the presence of a reaction catalyst. The blend ratio between the phenol and the aldehyde is preferably set within a molar ratio range of 1:0.5 to 1:3.5.

The term phenol includes phenol itself and phenol derivatives. Examples of the phenol include phenol, resorcinol, trifunctional compounds such as 3,5-xylenol, tetrafunctional compounds such as bisphenol A and dihydroxydiphenylmethane, and difunctional o-substituted or p-substituted phenols such as o-cresol, p-cresol, p-tert-butylphenol, p-phenylphenol, p-cumylphenol, p-nonylphenol, 2,4-xylenol and 2,6-xylenol. The phenol may also be a halogenated phenol that has been substituted with chlorine or bromine. Further, a single type of phenol may be used alone, or a combination of a plurality of types of phenol may be used.

The aldehyde is most preferably formalin, which exists in the form of an aqueous solution. Other compounds such as para-formaldehyde, acetaldehyde, benzaldehyde, trioxane and tetraoxane may also be used as the aldehyde. In the aldehyde, a portion of the formaldehyde may be substituted with 2-furaldehyde or furfuryl alcohol. Further, a single type of aldehyde may be used alone, or a combination of a plurality of types of aldehyde may be used.

When a novolac type phenol resin is prepared, an inorganic acid, an organic acid, or a divalent metal salt or the like can be used as the reaction catalyst. Examples of the inorganic acid include hydrochloric acid, sulfuric acid and phosphoric acid. Examples of the organic acid include oxalic acid, para-toluenesulfonic acid, benzenesulfonic acid and xylenesulfonic acid. Examples of the divalent metal salt include zinc acetate and the like.

When a resol type phenol resin is prepared, an oxide of an alkaline earth metal or a hydroxide of an alkaline earth metal can be used as the reaction catalyst. Further, an amine, ammonia, hexamethylenetetramine, or a hydroxide of another divalent metal can also be used as the reaction catalyst. Examples of the amine include dimethylamine, triethylamine, butylamine, dibutylamine, tributylamine, dimethylenetriamine and dicyandiamide.

The fibrous substance mainly performs the role of reinforcing the heat insulator when the heat insulator is formed. Although there are no particular limitations, the fibrous substance is preferably included within the heat insulator composition in a blend proportion of at least 1% by mass but not more than 50% by mass. If the proportion of the fibrous substance is less than 1% by mass, then a satisfactory reinforcing effect cannot be obtained. If the proportion of the fibrous substance exceeds 50% by mass, then the dispersibility of the fibrous substance within the heat insulator composition deteriorates, and there is a possibility that uniformity may be lost upon formation of the heat insulator.

There are no particular limitations on the fibrous substance, and oxide-based inorganic fibers, inorganic fibers and organic fibers or the like can be used. Examples of the oxide-based inorganic fibers include alumina fiber, glass fiber, silica fiber, and alumina-silica composite oxide fiber. Examples of the inorganic fibers include silicon carbide fiber, boron fiber and carbon fiber. Examples of the organic fibers include aramid fiber, poly(para-phenylbenzobisoxazole) fiber, acrylic fiber, acetate fiber, nylon fiber and vinylidene fiber.

In the present embodiment, the aforementioned fibrous substance employs a combination of two or more types of fibrous substances, comprising a first fibrous substance and a second fibrous substance. When a combination of a first fibrous substance and a second fibrous substance is used as the fibrous substance, the second fibrous substance is preferably included in an amount exceeding 0% by volume but not more than 50% by volume relative to the total volume of fibrous substances. In this case, the remainder is composed of the first fibrous substance.

A substance having a higher melting point than the second fibrous substance is selected as the first fibrous substance. The first fibrous substance provides heat resistance, and performs the role of improving recession. The melting point of the first fibrous substance is preferably 1,000° C. or higher. Ceramic-based fibers, carbon fiber (CF), silicon carbide fiber or Tyranno fiber (a registered trademark), silica fiber and alumina fiber and the like are ideal for use as the first fibrous substance.

The first fibrous substance may also be composed of a first fibrous substance group composed of a mixture of a plurality of types of fibrous substances having a higher melting point than the second fibrous substance.

A substance having a lower thermal conductivity than the first fibrous substance is selected as the second fibrous substance. The second fibrous substance performs the role of improving the heat insulation properties. Oxide-based fibers such as silica fiber, alumina fiber and glass fiber, poly(para-phenylbenzobisoxazole) fiber, polybenzimidazole fiber and polyimide fiber and the like are ideal for use as the second fibrous substance. When applied to use as a heat insulator (ablator) for a space shuttle, the second fibrous substance preferably has heat resistance of 300° C. or higher.

The second fibrous substance may also be composed of a second fibrous substance group composed of a mixture of a plurality of types of fibrous substances, the mixture having a lower thermal conductivity than the first fibrous substance.

The fiber diameters and fiber lengths of the first fibrous substance and the second fibrous substance may be the same or different. Although there are no particular limitations on the fiber diameter and the fiber length of the fibrous substances, the fiber diameter is preferably within a range from 1 μm to 30 μm, and the fiber length is preferably within a range from 1 mm to 30 mm. When the fiber length of the fibrous substances is short, the heat insulation properties can be improved when a heat insulator is formed. When the fiber length of the fibrous substances is long, the reinforcement effect can be enhanced when a heat insulator is formed. Accordingly, the fiber length of the fibrous substances may be set appropriately in accordance with the intended application.

The inorganic foam particles mainly perform the roles of lightening the weight when a heat insulator is formed, and lowering the thermal conductivity of the heat insulator, thereby improving the heat insulation performance. Although there are no particular limitations on the bulk specific gravity of the inorganic foam particles when a heat insulator is formed, the bulk specific gravity is preferably within a range from at least 0.05 to not more than 0.5. If the bulk specific gravity exceeds 0.5, then the weight reduction and heat insulation improvement effects cannot be adequately obtained. If the bulk specific gravity is less than 0.05, then the strength of the inorganic foam particles tends to decrease, meaning there is a possibility that the strength may deteriorate when a heat insulator is formed.

Although there are no particular limitations, the inorganic foam particles are preferably included within the heat insulator composition in a blend proportion of at least 5% by mass but not more than 50% by mass. If the blend proportion of the inorganic foam particles is less than 5% by mass, then the weight reduction and heat insulation improvement effects obtained by adding the inorganic foam particles cannot be adequately achieved, whereas if the blend proportion exceeds 50% by mass, there is a possibility that the strength may deteriorate when a heat insulator is formed.

There are no particular limitations on the inorganic foam particles, and hollow balloons or the like formed from a glass material or mineral can be used. Examples of the glass material include low-alkali glass, soda-lime glass, borosilicate glass, borosilicate-soda glass and aluminosilicate glass. A single type of inorganic foam particle may be used alone, or a combination of a plurality of types of inorganic foam particles may be used.

Although there are no particular limitations on the particle size of the inorganic foam particles, the particle size is preferably within a range from 1 μm to 1,000 μm.

The foaming agent has the role of foaming the thermosetting resin. By foaming the thermosetting resin with the foaming agent, the weight of the formed heat insulator can be reduced, and the thermal conductivity of the heat insulator can also be lowered, thus improving the heat insulation properties. The expansion ratio is preferably set within a range from approximately 2-fold to 5-fold. If the expansion ratio is less than 2-fold, then the weight reduction and heat insulation improvement effects cannot be adequately obtained. If the expansion ratio exceeds 5-fold, then the strength may deteriorate undesirably when a heat insulator is formed. The blend amount of the foaming agent may be set appropriately in accordance with the required expansion ratio. Although there are no particular limitations, the blend amount of the foaming agent is preferably within a range from 5 parts by mass to 20 parts by mass per 100 parts by mass of the thermosetting resin.

There are no particular limitations on the foaming agent, and inorganic foaming agents, organic foaming agents and microcapsule foaming agents and the like may be used. Examples of the inorganic foaming agents include ammonium carbonate and sodium bicarbonate. Examples of the organic foaming agents include dinitropentanemethylenetetramine, azodicarbonamide, p,p′-oxybenzenesulfonylhydrazine, and hydradicarbonamide. Examples of the microcapsule foaming agents include substances prepared by encapsulating a low-boiling point hydrocarbon in an outer shell composed of a copolymer of vinylene chloride, acrylonitrile or polyurethane or the like. A single type of inorganic foam particle may be used alone, or a combination of a plurality of types of inorganic foam particles may be used.

The composition for a heat insulator may also include a coupling agent. The coupling agent performs the role of enhancing the adhesion between the fibrous substances and inorganic foam particles, and the thermosetting resin. Examples of the coupling agent include γ-aminopropyltriethoxysilane, γ-(2-aminoethyl)aminopropyltrimethoxysilane, and γ-glycidoxypropyltrimethoxysilane.

The composition for a heat insulator may also include a polyvinyl alcohol-based material. Examples of the polyvinyl alcohol-based material include polyvinyl alcohol and polyvinyl acetal resin obtained by acetalizing polyvinyl alcohol. The polyvinyl alcohol-based material may be used in powdered form, or in a spun fibrous form such as vinylon fiber. When a fibrous material such as vinylon fiber is used as the polyvinyl alcohol-based material, a reinforcing effect can be obtained even at low temperatures when a heat insulator is formed. A single type of polyvinyl alcohol-based material may be used alone, or a combination of a plurality of types of material may be used.

Although there are no particular limitations, the polyvinyl alcohol-based material is preferably included within the heat insulator composition in a blend proportion of at least 1% by mass but not more than 20% by mass. If the proportion of the polyvinyl alcohol-based material is less than 1% by mass, then the effects obtained by adding the polyvinyl alcohol-based material cannot be adequately achieved. If the blend proportion of a non-fibrous polyvinyl alcohol-based material exceeds 20% by mass, then there is a possibility that the strength may deteriorate when a heat insulator is formed.

When a polyvinyl alcohol-based material is exposed to high temperature, even in an environment lacking oxygen, water is generated as the material decomposes. As the polyvinyl alcohol-based material decomposes, at the same time that thermal energy is consumed, additional thermal energy is also consumed as the vaporization heat of the generated water. Accordingly, a superior heat blocking effect caused by the consumption of thermal energy can be obtained.

The composition for a heat insulator may also include cork particles. Cork is obtained from the bark of the cork oak, which is an evergreen tree of the genus Quercus of the family Fagaceae grown in the Mediterranean region (such as Portugal, Spain and Italy). In the present embodiment, a material obtained by pulverizing and purifying the bark of the cork oak can be used as the cork particles. Cork has an ultra fine porous cellular structure, and this cellular structure means cork particles are lightweight and have superior heat insulation properties.

When a heat insulator is formed, the cork particles perform the roles of further reducing the weight of the insulator, as well as lowering the thermal conductivity and improving the heat insulation properties. On exposure to high temperature, the cork particles undergo decomposition, combustion, sublimation and carbonization, thereby consuming thermal energy. As a result, the high temperature is blocked from transmission through the heat insulator, meaning the heat insulation performance can be enhanced. A heat insulation effect can also be obtained due to the formation of a layer of gas at the surface of the heat insulator, the gas being generated from the cork particles as a result of thermal decomposition or the like.

Although there are no particular limitations on the particle size of the cork particles, the particle size is preferably within a range from approximately 1 μm to 2,000 μm. Although there are no particular limitations, the cork particles are preferably included within the heat insulator composition in a blend proportion of at least 5% by mass but not more than 40% by mass. If the blend proportion of the cork particles is less than 5% by mass, then the weight reduction and heat insulation improvement effects obtained by adding the cork particles tend to be difficult to achieve satisfactorily. If the blend proportion of the cork particles exceeds 40% by mass, there is a possibility that the strength of the heat insulator may deteriorate.

The composition for a heat insulator is prepared by combining at least the fibrous substances, the thermosetting resin, the inorganic foam particles and the foaming agent in the prescribed proportions, and then mixing the components with a mixing device. Examples of mixing devices which can be used include a Henschel mixer, Simpson mill, melanger, Eirich mixer, speed muller or whirl mixer. The mixing device may be selected appropriately in accordance with the state and properties of the binder component, or in accordance with the mixing method.

Next is a description of a heat insulator produced using the composition for a heat insulator prepared in the manner described above.

A heat insulator according to the present embodiment is produced by filling a mold with the aforementioned composition for a heat insulator, and then performing heating to melt the thermosetting resin and perform curing with the foaming agent in a foamed state. The heating temperature and the heating time and the like can be set appropriately in accordance with the type of thermosetting resin and the type of foaming agent incorporated within the heat insulator composition.

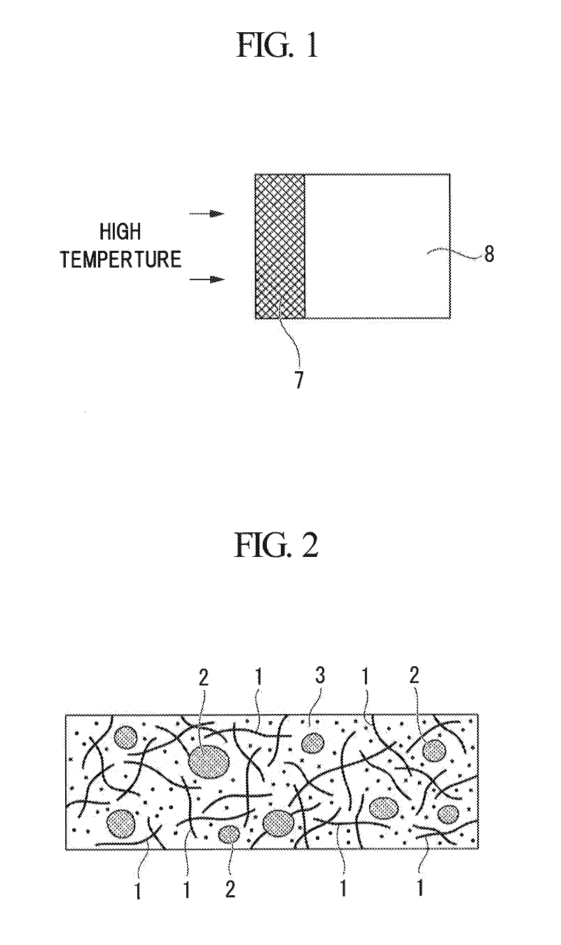

FIG. 1 illustrates a schematic cross-sectional view of the layer structure of a heat insulator according to the present embodiment. The heat insulator according to this embodiment has a 2-layer structure in which a heat insulation layer 7 is disposed on the surface side of the heat insulator, and another heat insulation layer 8 is disposed on the underside. When the heat insulator is applied to use on a space shuttle or reentry capsule or the like, the surface of the heat insulator refers to the surface disposed facing the outside of the airframe and exposed directly to high temperatures.

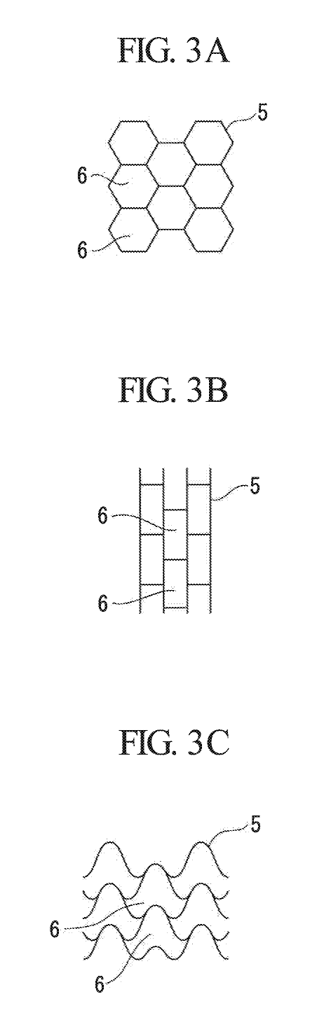

FIG. 2 illustrates a schematic cross-sectional view of the heat insulation layer 7 of the heat insulator according to the present embodiment. The heat insulation layer 7 is a layer in which a fibrous substance 1 and inorganic foam particles 2 are dispersed within a resin layer 3. The resin layer 3 is a layer that is formed by foaming the foaming agent contained in the heat insulator composition and curing the thermosetting resin. In FIG. 2, for the purpose of simplifying the figure, the fibrous substance 1 is illustrated as a single type of thread, but in the actual heat insulator, two or more types of fibrous substances formed from different materials (the first fibrous substance and the second fibrous substance) are mixed together.

In the heat insulation layer 7 of the heat insulator, the resin layer 3 functions as a matrix, and the inorganic foam particles 2 are incorporated within this matrix. As a result, the heat insulation layer 7 of the heat insulator can be formed with a small bulk density and a reduced thermal conductivity. Accordingly, a heat insulator that is lightweight and has superior heat insulation properties is obtained. Although there are no particular limitations, the bulk density of the heat insulator is typically not more than 1.0, and preferably within a range from at least 0.3 to not more than 1.0. The thermal conductivity of the heat insulator is typically not more than 0.2 W/(m·K), and is preferably within a range from at least 0.1 W/(m·K) to not more than 0.2 W/(m·K).

The fibrous substance 1 is dispersed within the resin layer 3. As a result, the heat insulator is reinforced, meaning the mechanical strength of the heat insulator can be enhanced. By mixing two or more types of fibrous substances formed from different materials, a heat insulator that combines the properties (advantages) of each fibrous substance can be obtained.

The heat insulation layer 7 may be formed so that the first fibrous substance is incorporated in a large amount at the surface side of the heat insulator, with the blend amount of the first fibrous substance decreasing in either a stepwise or a continuous manner in the direction of the underside of the layer.

The thickness (namely, the distance from the surface to the underside) of the heat insulation layer 7 disposed on the surface side of the heat insulator is set appropriately in accordance with the size of the region across which the first fibrous substance is preferably included. The region across which the first fibrous substance is preferably included may be set in accordance with the intended application, by estimating the degree to which heat will penetrate into the interior of the heat insulator during the length of time for which heating occurs on a given flight path. The composition for a heat insulator used in the first embodiment comprises a first fibrous substance which has a higher melting point than the second fibrous substance. For example, carbon fiber, which represents one possible material for the first fibrous substance, does not melt at high temperatures of approximately 2,000° C. As a result, by ensuring that the carbon fiber exists in a larger amount at the surface side of the heat insulator than the underside, recession can be suppressed. In the case where the heat insulator is applied to use on a reentry capsule, if the surface of the heat insulator (thickness: approximately 40 mm) is heated at 2 MW/m² for 200 seconds, then the region from the surface down to a depth of approximately 10 mm is preferably formed as a layer containing a large amount of carbon fiber. In other words, in the example described above, the thickness of the heat insulation layer 7 disposed on the surface side of the heat insulator is preferably approximately 10 mm.

The heat insulator according to the present embodiment is used in the open atmosphere or in space, and can be used, for example, as a heat insulator for protecting an airframe that is flown at high speed, such as a spacecraft. A spacecraft refers to a space shuttle or a reentry capsule or the like.

The other heat insulation layer 8 disposed on the underside of the heat insulator is formed by foaming and curing a different heat insulator composition from the heat insulator composition used for the heat insulation layer 7.

This different heat insulator composition has the same composition as that of the heat insulation layer 7 with the exception of the fibrous substance. The different heat insulator composition contains only the second fibrous substance as the fibrous substance. The second fibrous substance is a fibrous substance with a lower thermal conductivity than the first fibrous substance incorporated within the heat insulation layer 7. For example, an oxide-based inorganic fiber such as silica fiber or alumina fiber is ideal as the second fibrous substance. This second fibrous substance has the role of improving the heat insulation properties. When applied to use as a heat insulator (ablator) for a space shuttle or a reentry capsule, the second fibrous substance preferably has heat resistance of 500° C. or higher.

The second fibrous substance may also be composed of a second fibrous substance group composed of a mixture of a plurality of types of fibrous substances, the mixture having a lower thermal conductivity than the first fibrous substance.

The fiber diameter and fiber length of the second fibrous substance may be the same as, or different from, those of the first fibrous substance incorporated within the heat insulation layer 7. Although there are no particular limitations on the fiber diameter and the fiber length of the second fibrous substance, the fiber diameter is preferably within a range from 1 μm to 30 μm, and the fiber length is preferably within a range from 1 mm to 30 mm. The fiber length of the fibrous substance may be set appropriately in accordance with the intended application.

The heat insulator according to the present embodiment can be integrally molded, for example by injecting the heat insulator composition uniformly into the cavity of a mold, subsequently injecting a different heat insulator composition on top of the first composition, and then heating the mold to foam the foaming agent, and melt and cure the thermosetting resin. In those cases where the heat insulator has a multilayer structure, if each layer is cured individually, then there is some concern that damage may occur at the layer interface between the stacked layers, but by performing integral molding, this concern can be eliminated. Further, if each layer is cured individually, then the curing operation must be repeated multiple times, resulting in increased production costs, but by performing integral molding, the operational efficiency can be improved and production costs can be lowered.

An airframe being flown at high speed is exposed to high temperatures as a result of friction with the atmosphere. In particular, when an airframe reenters the earth's atmosphere from space, aerodynamic heating reaches approximately 1 MW/m² to 5 MW/m², meaning the airframe is exposed to extremely high temperature. When the surface of the heat insulator is exposed to high temperature, the resin layer 3 which functions as the matrix undergoes decomposition, melting or sublimation, or combustion and carbonization, and thermal energy is consumed as a result of the latent heat absorption which accompanies the material phase change. This consumption of thermal energy can block transmission of the high temperature through the heat insulator. Further, the gas generated as a result of decomposition or sublimation is ejected from the surface of the heat insulator, and performs a role of shielding the surface of the heat insulator. This shield reduces the direct action of the extreme aerodynamic heating on the heat insulator, and therefore the high temperature can be blocked from transmission through the heat insulator. As a result of this insulation action, the heat insulator according to the present embodiment can protect the interior of the airframe from high temperatures.

In the heat insulator of the present embodiment, the heat insulation layer on the surface side is a layer containing a mixture of two or more types of fibrous substance, and mainly has the role of reducing the amount of recession. The other heat insulation layer on the underside is composed of a material with a low thermal conductivity, and has the primary function of heat insulation. By providing this other heat insulation layer on the underside, the heat insulation properties of the heat insulator can be improved, and the amount of recession can be further reduced. This type of heat insulator is ideal for application to the airframes of spacecraft in which the surface temperature is exposed to high temperatures for a short period of time, such as space shuttles and reentry capsules.

### Modified Examples of First Embodiment

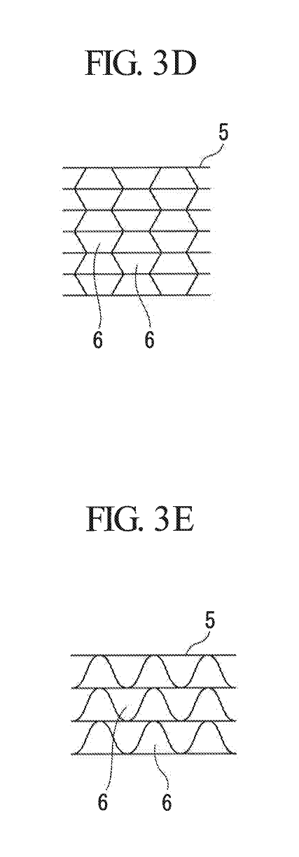

The composition for a heat insulator may be used to fill the spaces in a honeycomb structure. A honeycomb structure is a structure in which a plurality of spaces which are open at the surface are disposed in a regular arrangement. Examples of the shape of these spaces are illustrated in FIG. 3(A) to FIG. 3(E). The shape of the spaces 6 is not limited to the shape shown in FIG. 3(A), and shapes such as those shown in FIG. 3(B) to FIG. 3(E) may also be used. Honeycomb structures having the shapes illustrated in FIG. 3(B) to FIG. 3(E) can be acquired, for example, from Showa Aircraft Industry Co., Ltd., under the brand names “OX”, “Flex”, “Bisect” and “Feather”. The shape of the spaces 6 may be selected appropriately in accordance with the intended application.

The material of the honeycomb structure 5 may be a paper, a metal, or a composite material or the like. Examples of the paper include normal paper and flame-retardant paper. Examples of the metal include aluminum, stainless steel and titanium. Examples of the composite material include aramid paper, poly(para-phenylenebenzobisoxazole) paper, and carbon-glass. In order to reduce the weight of the honeycomb structure 5, the use of aramid paper as the material for the structure is ideal.

Filling of the spaces 6 of the honeycomb structure 5 with the composition for a heat insulator is performed, for example, by setting the honeycomb structure inside a mold, and then injecting the heat insulator composition into the mold. By subsequently performing heating and curing, the spaces 6 in the honeycomb structure 5 are filled with the heat insulator. In a heat insulator produced in this manner, because the honeycomb structure functions as a framework, the strength of the heat insulator increases. Further, the shape retention properties are also favorable, resulting in a heat insulator with excellent handling properties.

### Example 1

In Example 1, a heat insulator composition A described below was used to prepare a heat insulator.

### <<Heat Insulator Composition A>>

Thermosetting resin: curing agent-containing novolac type phenol resin (11 parts by mass)/resol type phenol resin varnish (52 parts by weight, solid fraction equivalent: 34 parts by mass)

Fibrous substance: carbon fiber (7.5 parts by mass)/silica fiber (7.5 parts by mass)

Inorganic foam particles: aluminosilicate-based microballoons (40 parts by mass)

Foaming agent: microcapsule foaming agent (5.5 parts by mass)

Specifically, a reaction container was charged with 940 parts by mass of phenol, 649 parts by mass of 37% by mass formalin and 4.7 parts by mass of oxalic acid, and the mixture was refluxed for approximately 60 minutes, and then left to react for 120 minutes. Following deliquoring under normal pressure at an internal temperature of up to 160° C., further deliquoring was performed under reduced pressure at 133 hPa, yielding a novolac type phenol resin with a softening point of 99° C.

The thus obtained novolac type phenol resin was placed in a hammer mill and crushed to a particle size of not more than 106 μm to obtain a powder. To 100 parts by mass of this powdered novolac type phenol resin was added 10 parts by mass of hexamethylenetetramine as a curing agent. These components were then mixed thoroughly, yielding the curing agent-containing novolac type phenol resin.

A reaction container was charged with 940 parts by mass of phenol, 649 parts by mass of 37% by mass formalin and 23.5 parts by mass of a sodium hydroxide aqueous solution with a concentration of 48% by mass, and the mixture was refluxed for approximately 60 minutes, and then left to react for 90 minutes. Deliquoring was performed under reduced pressure at 133 hPa at a temperature of up to 100° C., yielding a semisolid resol type phenol resin.

Methanol was added as a solvent to the thus obtained resol type phenol resin, yielding a resol type phenol resin varnish having a solid fraction of 65% by mass. The resol type phenol resin varnish had a viscosity at 25° C. of 160 mPa·s.

The carbon fiber (CF, the first fibrous substance) used a product “TR-066” manufactured by Mitsubishi Rayon Co., Ltd., having a fiber diameter of 6 μm and a fiber length of 6 mm. The silica fiber (SF, the second fibrous substance) used a product “KA-300E” manufactured by Ashimori Industry Co., Ltd., having a fiber diameter of 6 μm and a fiber length of 5 mm. The inorganic foam particles employed a product “Fillite 200/7” manufactured by Japan Fillite Co., Ltd., having a particle size of 5 μm to 150 μm and a bulk specific gravity of 0.4. The foaming agent employed a product “Microsphere F-50” manufactured by Matsumoto Yushi-Seiyaku Co., Ltd.

Each of the above components was placed in a Henschel mixer, and the mixture was mixed for 10 minutes. Next, the mixture was transferred to a stainless steel vat and left to stand at room temperature for 24 hours to allow the methanol to evaporate, thus forming a powdered heat insulator composition.

Subsequently, 56 g of the thus obtained heat insulator composition was placed in a mold having a cavity with a diameter of 50 mm and a height of 60 mm. The mold containing the heat insulator composition was placed in a hot air circulating dryer that had been preset to 135° C., and was heated at 135° C. for one hour. The temperature was then raised to 175° C., and heating was performed at 175° C. for one hour, thereby melting and curing the thermosetting resin, and foaming the foaming agent to complete formation of the heat insulator. Subsequently, the mold was cooled and the heat insulator was removed.

### Example 2

In Example 2, the heat insulator composition A and the heat insulator composition B described below were used to prepare a heat insulator. The heat insulator composition A had the same composition as that of Example 1. The heat insulator composition B contained only silica fiber (the second fibrous substance) as the fibrous substance, but was otherwise prepared in the same manner as the heat insulator composition A.

### <<Heat Insulator Composition B>>

Thermosetting resin: curing agent-containing novolac type phenol resin (11 parts by mass)/resol type phenol resin varnish (52 parts by weight, solid fraction equivalent: 34 parts by mass)

Fibrous substance: silica fiber (15 parts by mass)

Inorganic foam particles: aluminosilicate-based microballoons (40 parts by mass)

Foaming agent: microcapsule foaming agent (5.5 parts by mass)

First, 28 g of the heat insulator composition A obtained above and 28 g of the heat insulator composition B were placed in a mold having a cavity with a diameter of 50 mm and a height of 60 mm. The mold containing the heat insulator compositions A and B was heated in the same manner as that described in Example 1, thereby melting and curing the thermosetting resin, and foaming the foaming agent to complete formation of the heat insulator. Subsequently, the mold was cooled and the heat insulator was removed.

### Comparative Example 1

In Comparative Example 1, a heat insulator composition C described below was used to prepare a heat insulator in the same manner as that described for Example 1. The heat insulator composition C contained only carbon fiber (the first fibrous substance) as the fibrous substance, but otherwise had the same composition as the heat insulator composition A.

### <<Heat Insulator Composition C>>

Thermosetting resin: curing agent-containing novolac type phenol resin (11 parts by mass)/resol type phenol resin varnish (52 parts by weight, solid fraction equivalent: 34 parts by mass)

Fibrous substance: carbon fiber (15 parts by mass)

Inorganic foam particles: aluminosilicate-based microballoons (40 parts by mass)

Foaming agent: microcapsule foaming agent (5.5 parts by mass)

### Comparative Example 2

In Comparative Example 2, the heat insulator composition B was used to prepare a heat insulator in the same manner as that described for Example 1. The heat insulator composition B was prepared in the same manner as that described in Example 2.

Each of the heat insulators of Examples 1 and 2 and Comparative Examples 1 and 2 was subjected to an arc-heated wind tunnel test. This test was performed using a 750 kW arc-heated wind tunnel owned by the JAXA Wind Tunnel Technology Center, under conditions including a heating rate of 2.0 MW/m², a heating time of 200 seconds, and a test piece size of ø40 mm×58 mm. The thickness of the surface region that was damaged was measured and recorded as the amount of recession. Further, the internal temperature of the test piece was also measured. The internal temperature of the test piece was measured using a thermocouple that had been embedded in advance at a predetermined position inside the test piece (namely, a position 20 mm from the heated surface).

TABLE 1

| | | | | Comparative | Comparative |
|---|---|---|---|---|---|
| Test Piece | Example 1 | Example 2 | | Example 1 | Example 2 |
| Type of | CF + SF | CF + SF/SF | | CF | SF |
| mixed | | surface | underside | | |
| fiber | | layer | layer | | |
| CF blend | 50 | 50 | 0 | 100 | 0 |
| proportion | | | | | |
| SF blend | 50 | 50 | 50 | 0 | 100 |
| proportion | | | | | |

| | | | | |
|---|---|---|---|---|
| Amount of | 10.30 | 7.00 | 6.67 | 7.68 |
| recession | | | | |
| (mm) | | | | |
| Internal | 176.22 | 63.69 | 368.0 | 49.8 |
| tempera- | | | | |
| ture | | | | |
| of test | | | | |
| piece | | | | |
| (° C.) | | | | |

Table 1 reveals that the heat insulator containing only carbon fiber (Comparative Example 1) exhibited an amount of recession that was approximately 1 mm less than that of the heat insulator containing only silica fiber (Comparative Example 2), but displayed a test piece internal temperature that was more than 300° C. higher. The heat insulators comprising a heat insulation layer containing a mixture of carbon fiber and silica fiber (Example 1 and Example 2) exhibited lower test piece internal temperatures than Comparative Example 1, and smaller amounts of recession than Comparative Example 2. These results confirmed that by mixing carbon fiber and silica fiber, a heat insulator that combines the advantages of each fibrous substance could be obtained. Furthermore, in Example 2 in which the heat insulator had a 2-layer structure, the internal temperature of the test piece could be maintained at a lower temperature while suppressing the amount of recession.

### REFERENCE SIGNS LIST

1 Fibrous substance
2 Inorganic foam particles
3 Resin layer
5 Honeycomb structure
6 Space
7 Heat insulation layer
8 Other heat insulation layer

1. A composition for a heat insulator comprising a fibrous substance, inorganic foam particles, a thermosetting resin and a foaming agent, wherein
the fibrous substance comprises at least a first fibrous substance, and a second fibrous substance composed of a material different from the first fibrous substance,
a melting point of the first fibrous substance is higher than a melting point of the second fibrous substance, and
a thermal conductivity of the second fibrous substance is lower than a thermal conductivity of the first fibrous substance.

2. A heat insulator comprising:
a heat insulation layer obtained by foaming and curing a composition A for a heat insulator comprising at least inorganic foam particles, a thermosetting resin, a foaming agent, a first fibrous substance, and a second fibrous substance composed of a material different from the first fibrous substance, wherein
a melting point of the first fibrous substance is higher than a melting point of the second fibrous substance, and
a thermal conductivity of the second fibrous substance is lower than a thermal conductivity of the first fibrous substance, and
an other heat insulation layer obtained by foaming and curing a composition B for a heat insulator comprising inorganic foam particles, a thermosetting resin, a foaming agent, and only the second fibrous substance as a fibrous substance, wherein
the other heat insulation layer is disposed on an underside of the heat insulation layer.

3. The heat insulator according to claim 2, wherein in the heat insulation layer,
a proportion of the first fibrous substance relative to a total amount of fibrous substances is increased in either a stepwise or a continuous manner from an underside toward a surface side of the heat insulation layer.

4. The heat insulator according to claim 2, wherein the heat insulator is formed by foaming and curing the composition A for a heat insulator and the composition B for a heat insulator inside spaces within a honeycomb structure.

5. A spacecraft, comprising the heat insulator according to claim 2.
